(19) United States
(12) Patent Application Publication
(10) Pub. No.: US 2015/0121509 A1
(43) Pub. Date: Apr. 30, 2015

(54) DISPLAY APPARATUS THAT DISPLAYS ONE-TIME PASSWORD

(71) Applicant: Kyocera Document Solutions Inc., Osaka (JP)

(72) Inventors: Yosuke Nakazato, Osaka (JP); Yoshitaka Matsuki, Osaka (JP); Makoto Kowaka, Osaka (JP)

(21) Appl. No.: 14/529,228

(22) Filed: Oct. 31, 2014

(30) Foreign Application Priority Data
Oct. 31, 2013 (JP) 2013-227759

(51) Int. Cl. H04L 29/06; G06F 21/31

(52) U.S. Cl. CPC H04L 63/0838; G06F 21/31
USPC 726/18

(57) ABSTRACT

A display apparatus includes a display panel, a display condition setting unit that defines a specified display point in a specific screen as a display point of a one-time password for a specified user and sets a display condition for the one-time password, and a password display unit that displays, to the specified user, the one-time password at a display point included in the display condition based on the display condition set by the display condition setting unit when the specific screen is displayed in the display panel.

### REFERENCE TO RELATED APPLICATIONS

This application is based upon and claims the benefit of priority from the corresponding Japanese Patent Application No. 2013-227759, filed in the Japan Patent Office on Oct. 31, 2013, the entire contents of which are incorporated herein by reference.

### FIELD

The present disclosure relates to a display apparatus that displays a one-time password.

### BACKGROUND

In a typical display method for a one-time password, the password is constantly displayed at the same point, in other words, at a fixed point in an input screen. Therefore, even if anyone views, the one-time password is read in the same way.

### SUMMARY

A display apparatus according to an embodiment of the present disclosure includes a display panel, a display condition setting unit, and a password display unit. The display condition setting unit defines a specified display point in a specific screen as a display point of a one-time password for a specified user and sets a display condition for the one-time password. The password display unit displays, to the specified user, the one-time password at a display point included in the display condition based on the display condition set by the display condition setting unit when the specific screen is displayed in the display panel.

A display method according to an embodiment of the present disclosure includes setting, via a display condition setting unit, a display condition of a one-time password while defining a specified display point in a specific screen as a display point for the one-time password for a specified user, and displaying, via a password display unit, the one-time password at a display point included in the display condition, to the specified user, based on the display condition set by the display condition setting unit when the specific screen is displayed in a display panel.

A non-transitory computer-readable recording medium according to an embodiment of the present disclosure stores therein a display program executable by a computer. The display program includes first and second program codes. The first program code causes the computer to define a specified display point in a specific screen as a display point for a one-time password for a specified user and set a display condition of the one-time password. The second program code causes the computer to display, to the specified user, the one-time password at a display point included in the display condition based on the display condition set by the first program code when the specific screen is displayed in a display panel.

Additional features and advantages are described herein, and will be apparent from the following detailed description and the figures.

### BRIEF DESCRIPTION OF THE DRAWINGS

All drawings are intended to illustrate some aspects and examples of the present disclosure. The drawings described are only schematic and are non-limiting, and are not necessarily drawn to scale.

FIG. 1 illustrates an image forming system according to an embodiment of the present disclosure;

FIG. 2 illustrates a configuration of an MFP illustrated in FIG. 1;

FIG. 3 illustrates a configuration of a server illustrated in FIG. 1;

FIG. 4 illustrates an example of password display condition information illustrated in FIG. 3;

FIG. 5 illustrates an example of password information illustrated in FIG. 3;

FIG. 6 illustrates steps of an operation of the MFP illustrated in FIG. 2 at the time of setting a password display condition;

FIG. 7 illustrates an example of a user registration screen displayed in a display panel of the MFP illustrated in FIG. 2;

FIG. 8 illustrates an example of a system menu screen displayed in the display panel of the MFP illustrated in FIG. 2;

FIG. 9 illustrates an example of an address book screen displayed in the display panel of the MFP illustrated in FIG. 2;

FIG. 10 illustrates an example of the address book screen illustrated in FIG. 9 in a state where display points of variable characters are specified;

FIG. 11 illustrates steps of an operation of the MFP illustrated in FIG. 2 at the time of authenticating a user using a one-time password;

FIG. 12 illustrates an example of an authentication screen displayed in the display panel of the MFP illustrated in FIG. 2;

FIG. 13 illustrates an example of the address book screen illustrated in FIG. 9 in a state where a one-time password is displayed;

FIG. 14 illustrates an example different from the example of the password display condition information illustrated in FIG. 4; and

FIG. 15 illustrates an example of a transmission screen displayed in the display panel of the MFP illustrated in FIG. 2.

### DETAILED DESCRIPTION

Various embodiments are described below with reference to the figures. It should be understood, however, that numerous variations from the depicted arrangements and functions are possible while remaining within the scope and spirit of the claims. For instance, one or more elements may be added, removed, combined, distributed, substituted, re-positioned, re-ordered, and/or otherwise changed. Further, where this description refers to one or more functions being implemented on and/or by one or more devices, one or more machines, and/or one or more networks, it should be understood that one or more of such entities could carry out one or more of such functions by themselves or in cooperation, and may do so by application of any suitable combination of hardware, firmware, and/or software. For instance, one or more processors may execute one or more sets of programming instructions as at least part of carrying out one or more of the functions described herein.

Hereinafter, an embodiment of the present disclosure will be described using drawings.

First, the configuration of an image forming system serving as a one-time password display system according to an embodiment will be described.

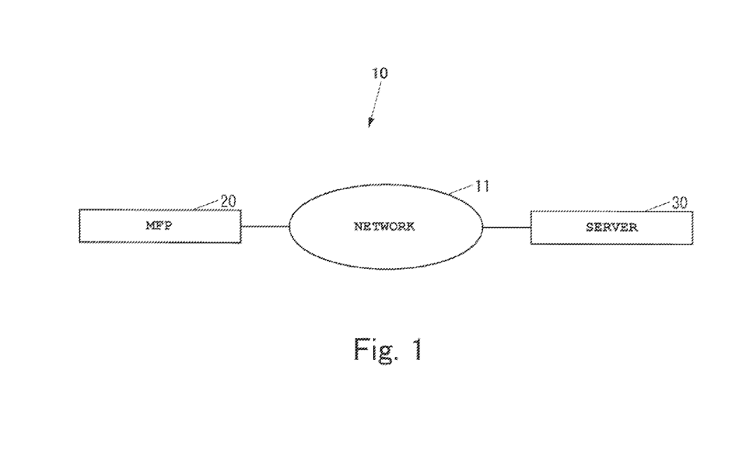

FIG. 1 illustrates the configuration of an image forming system 10 according to an embodiment.

As illustrated in FIG. 1, the image forming system 10 includes a multifunction peripheral (MFP) 20 serving as a one-time password display apparatus, and a server 30 serving as a computer for managing the MFP 20. The MFP 20 and the server 30 are connected via a network 11 such as a local area network (LAN) or Internet so as to be able to communicate with each other.

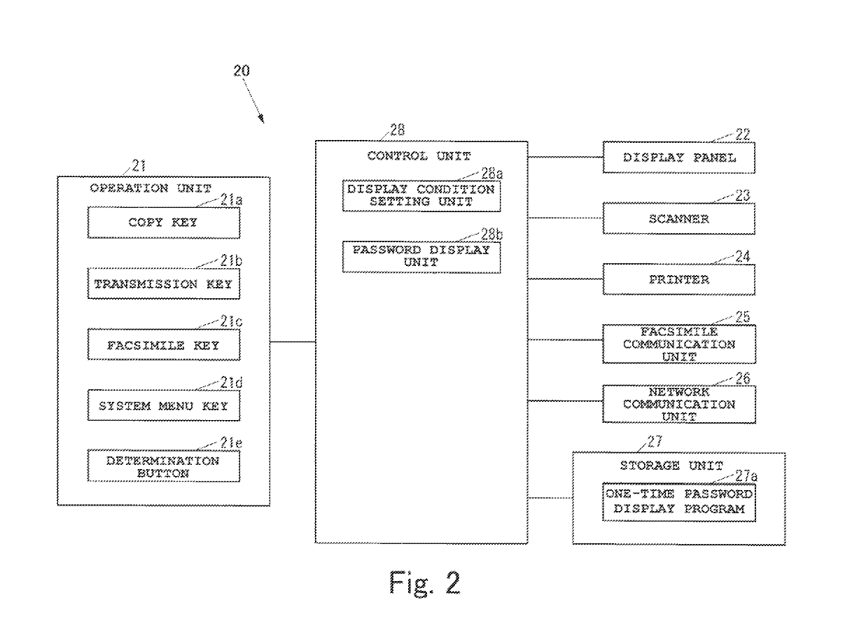

FIG. 2 illustrates the configuration of the MFP 20.

As illustrated in FIG. 2, the MFP 20 includes an operation unit 21, a display panel 22, a scanner 23, a printer 24, a facsimile communication unit 25, a network communication unit 26, a storage unit 27, and a control unit 28. The operation unit 21 is an input device such as buttons, through which various operations based on a user are to be inputted. The display panel 22 is a device such as a liquid crystal display (LCD) for displaying various kinds of information. The scanner 23 reads an image from a manuscript. The printer 24 executes printing for a recording medium such as paper. The facsimile communication unit 25 performs facsimile communication with an external facsimile apparatus not illustrated, through a communication line such as a public telephone line. The network communication unit 26 communicates with an external apparatus through the network 11 (see FIG. 1). The storage unit 27 is a non-volatile storage device such as an electrically erasable programmable read only memory (EEPROM) or a hard disk drive (HDD), which stores therein various kinds of data. The control unit 28 controls the whole MFP 20.

The operation unit 21 includes a copy button 21a, a transmission button 21b, a facsimile button 21c, a system menu button 21d, and a determination button 21e. The copy button 21a is hardware used for displaying, in the display panel 22, a copy screen for receiving an operation relating to copying in which an image read from a manuscript by the scanner 23 is printed on a recording medium by the printer 24. The transmission button 21b is hardware used for displaying, in the display panel 22, a transmission screen for receiving an operation relating to transmission via the network communication unit 26. The facsimile button 21c is hardware used for displaying, in the display panel 22, a facsimile transmission screen for receiving an operation relating to facsimile transmission via the facsimile communication unit 25. The system menu button 21d is hardware used for displaying, in the display panel 22, a system menu screen indicating a system menu. The determination button 21e is hardware used for determining various kinds of selection. The operation unit 21 may include an input device forming a touch panel in coordination with the display panel 22.

The storage unit 27 stores therein a one-time password display program 27a to be executed by the MFP 20. The one-time password display program 27a may be installed into the MFP 20 in the manufacturing stage of the MFP 20, may be installed into the MFP 20 from a storage medium such as an SD card or a universal serial bus (USB) memory, and may be installed into the MFP 20 from the network 11.

The control unit 28 includes, for example, a central processing unit (CPU), a read only memory (ROM) storing therein a program and various kinds of data, and a random access memory (RAM) to be used as the working area of the CPU. The CPU executes the program stored in the ROM or the storage unit 27.

By executing the one-time password display program 27a stored in the storage unit 27, the control unit 28 functions as a display condition setting unit 28a and a password display unit 28b. The display condition setting unit 28a sets the display condition of a one-time password (hereinafter, referred to as a “password display condition”) including a display point of the one-time password (hereinafter, referred to as a “password display point”). The password display unit 28b causes the display panel 22 to display the one-time password.

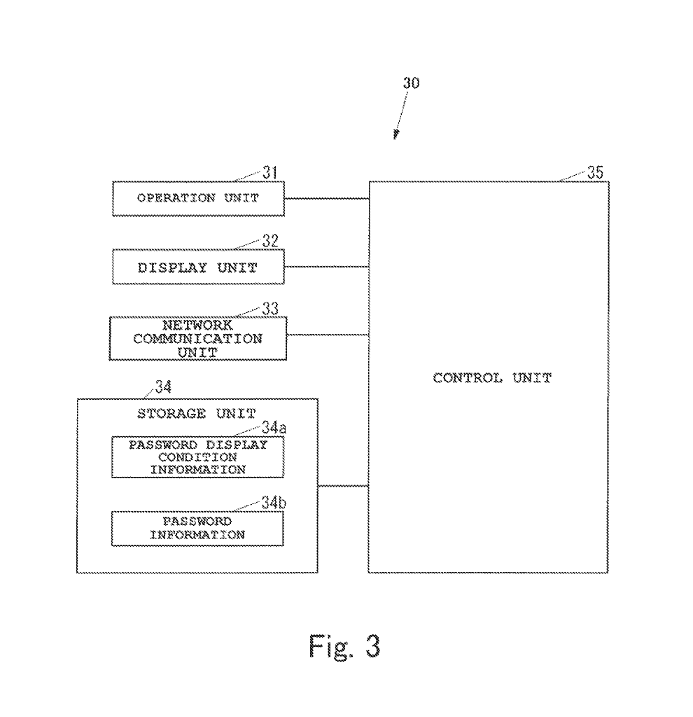

FIG. 3 illustrates the configuration of the server 30.

As illustrated in FIG. 3, the server 30 includes an operation unit 31, a display unit 32, a network communication unit 33, a storage unit 34, and a control unit 35. The operation unit 31 is an input device such as a mouse or a keyboard, through which various operations are inputted. The display unit 32 is a display device such as an LCD, used for displaying various kinds of information. The network communication unit 33 is a network communication device for communicating with an external apparatus through the network 11 (see FIG. 1). The storage unit 34 is a non-volatile storage device such as an HDD that stores therein a program and various kinds of data. The control unit 35 controls the whole server 30. The server 30 includes, for example, a computer such as a personal computer (PC).

The storage unit 34 is able to store therein password display condition information 34a indicating a password display condition.

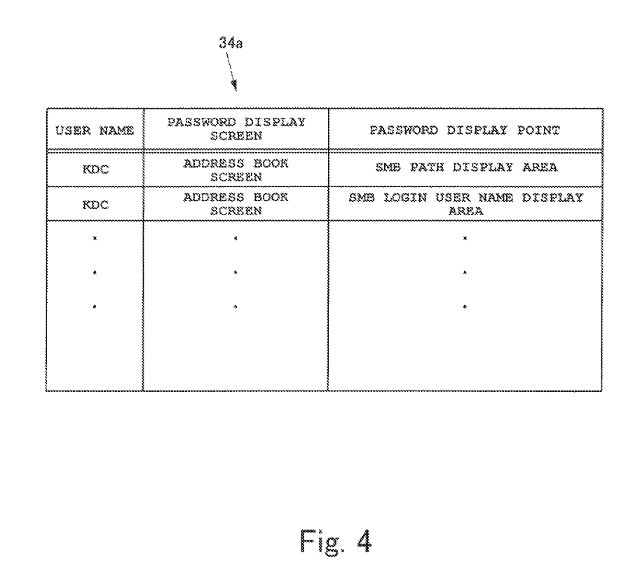

FIG. 4 illustrates an example of the password display condition information 34a.

As illustrated in FIG. 4, the password display condition information 34a is information including, with respect to each user name, a password display condition serving as the combination of the user name, a specific screen, in other words, the display screen of a one-time password (hereinafter, referred to as a “password display screen”), and a password display point. In the password display condition information 34a illustrated in, for example, FIG. 4, a password display screen and a password display point for a user name, “KDC”, are an address book screen and an SMB path display area, respectively.

As illustrated in FIG. 3, the storage unit 34 is able to store therein password information 34b including a one-time password.

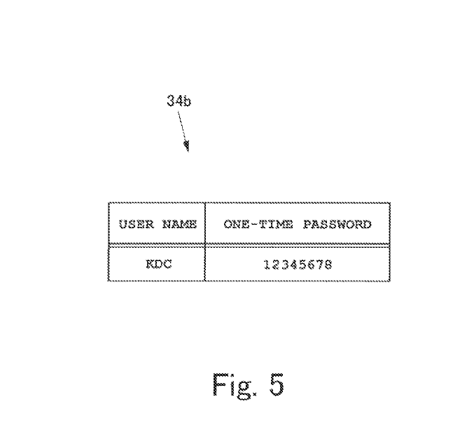

FIG. 5 illustrates an example of the password information 34b.

As illustrated in FIG. 5, the password information 34b is a combination of a user name and a one-time password. In the example of FIG. 5, the password information 34b is the combination of the user name, “KDC”, and a one-time password, “12345678”.

The control unit 35 illustrated in FIG. 3 includes, for example, a CPU, a ROM storing therein a program and various kinds of data, and a RAM used as the working area of the CPU. The CPU executes the program stored in the ROM or the storage unit 34.

Next, the operation of the image forming system 10 will be described.

First, the operation of the image forming system 10 at the time of setting a password display condition will be described.

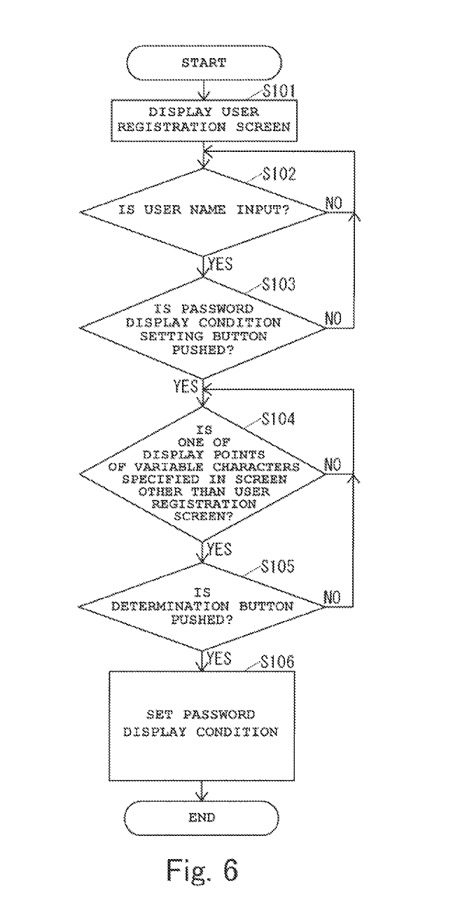

Upon being instructed to start a setting operation for the password display condition via the operation unit 21, the control unit 28 in the MFP 20 executes an operation illustrated in FIG. 6.

FIG. 6 illustrates steps of the operation of the MFP 20 at the time of setting the password display condition.

As illustrated in FIG. 6, the display condition setting unit 28a in the control unit 28 displays a user registration screen 40 in the display panel 22 (S101).

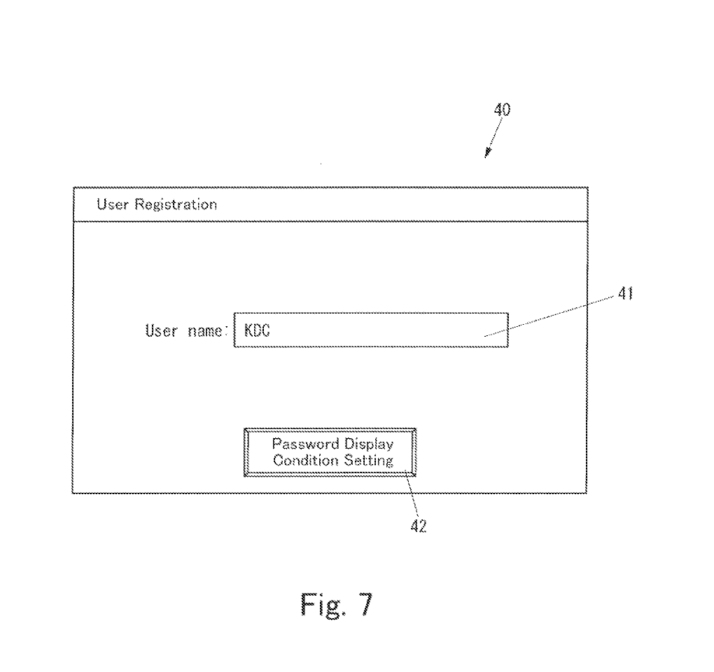

FIG. 7 illustrates an example of the user registration screen 40 displayed in the display panel of the MFP 20. The user registration screen 40 illustrated in FIG. 7 includes a user name setting text box 41 for setting a user name, and a password display condition setting button 42 for setting the password display condition. A user is able to input the user name to the user name setting text box 41 via the operation unit 21, and is able to push the password display condition setting button 42 via the operation unit 21.

As illustrated in FIG. 6, if the processing operation in S101 is terminated, the display condition setting unit 28a determines whether or not the user name is inputted to the user name setting text box 41 until determining that the user name is inputted to the user name setting text box 41 (S102).

If, in S102, determining that the user name is inputted to the user name setting text box 41, the display condition setting unit 28a determines whether or not the password display condition setting button 42 is pushed (S103).

If, in S103, determining that the password display condition setting button 42 is not pushed, the display condition setting unit 28a executes the processing operation in S102.

If, in S103, determining that the password display condition setting button 42 is pushed, the display condition setting unit 28a determines whether or not one of the display points of variable characters is specified in a screen other than the user registration screen 40 until determining that one of the display points of variable characters is specified in a screen other than the user registration screen 40 (S104).

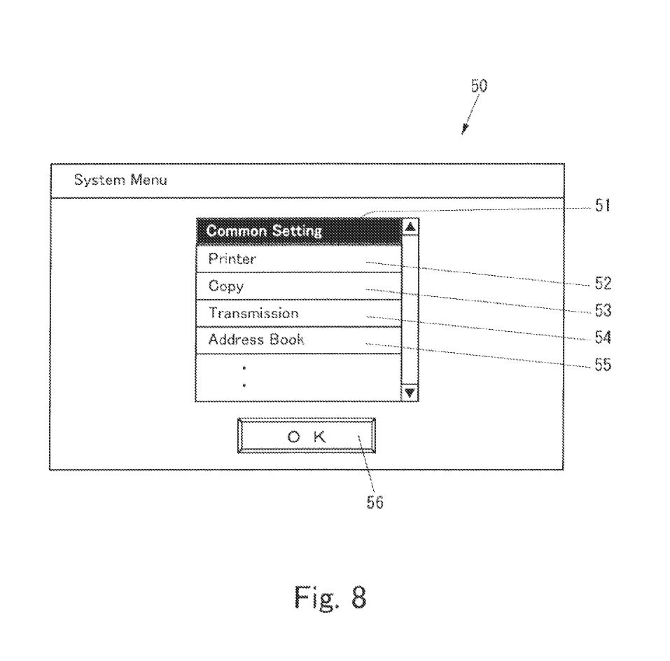

For example, the system menu button 21d is pushed, and thus the control unit 28 causes the display panel 22 to display a system menu screen 50 illustrated in FIG. 8.

As individual items of a system menu, the system menu screen 50 illustrated in FIG. 8 includes, for example, a common setting item 51 used for specifying a common setting, a printer item 52 used for specifying the setting of the printer 24, a copy item 53 used for specifying the setting of copying, a transmission item 54 used for specifying the setting of transmission, and an address book item 55 used for specifying the setting of an address book. In addition, the system menu screen 50 includes an OK button 56 used for determining one of the individual items of the system menu.

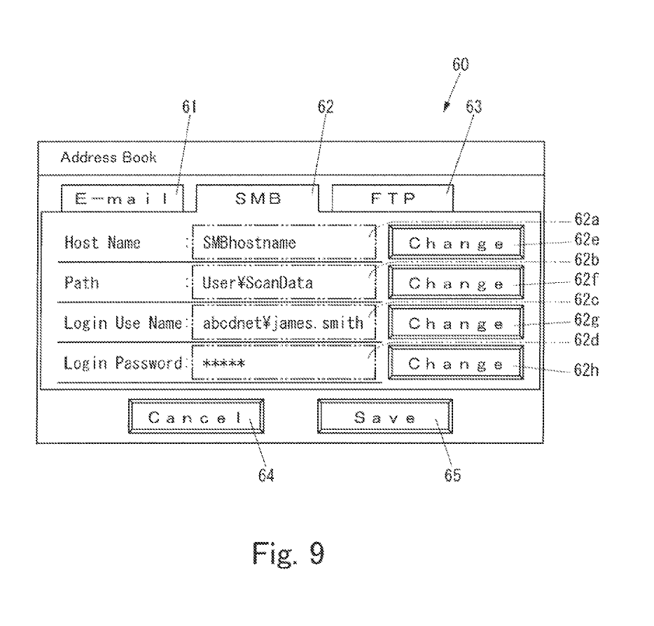

For example, the address book item 55 is specified and the OK button 56 is pushed, via the operation unit 21, and thus the control unit 28 causes the display panel 22 to display an address book screen 60 illustrated in FIG. 9.

The address book screen 60 illustrated in FIG. 9 includes an E-mail tab 61 used for setting the destination of an e-mail, an SMB tab 62 used for setting the destination of a server message block (SMB), an FTP tab 63 used for setting the destination of a file transfer protocol (FTP), a Cancel button 64 used for cancelling a change in a setting, and a Save button 65 used for storing a change in a setting.

The SMB tab 62 includes an SMB host name display area 62a used for displaying the host name of an SMB, an SMB path display area 62b used for displaying the path of the SMB, an SMB login user name display area 62c used for displaying the login user name of the SMB, and an SMB login password display area 62d used for displaying the login password of the SMB. Here, the host name, the path, the login user name, and the login password of the SMB are individually variable characters. Accordingly, each of the SMB host name display area 62a, the SMB path display area 62b, the SMB login user name display area 62c, and the SMB login password display area 62d is the display point of variable characters. In addition, in FIG. 9, two-dot chain lines indicating the SMB host name display area 62a, the SMB path display area 62b, the SMB login user name display area 62c, and the SMB login password display area 62d are lines indicated for facilitating understanding, and are not actually displayed in the display panel 22.

In addition, the SMB tab 62 includes Change buttons 62e, 62f, 62g, and 62h used for changing the host name, the path, the login user name, and the login password, respectively, of the SMB.

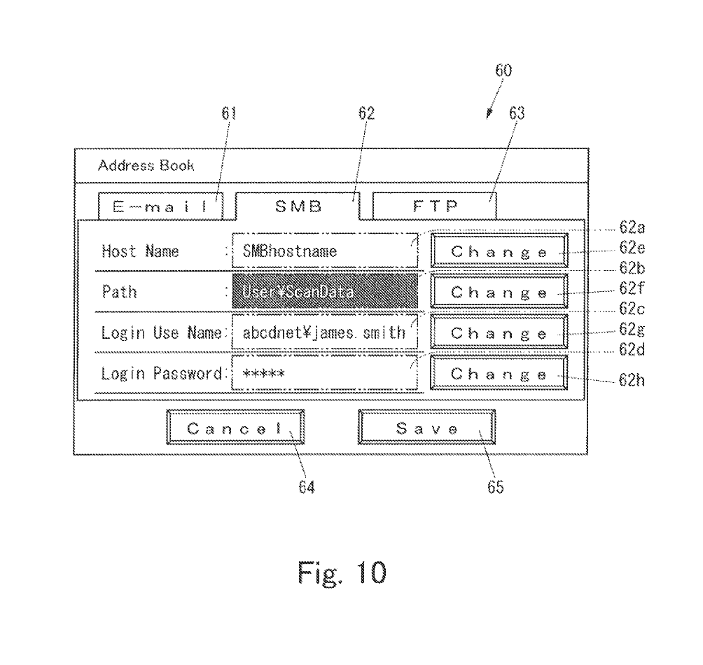

Via the operation unit 21, the user is able to specify, for example, the SMB path display area 62b. If the SMB path display area 62b is specified via the operation unit 21, the display condition setting unit 28a subjects the SMB path display area 62b to a highlighted display, as illustrated in FIG. 10.

As illustrated in FIG. 6, if, in S104, determining that one of the display points of variable characters is specified in a screen other than the user registration screen 40, the display condition setting unit 28a determines whether or not the determination button 21e is pushed (S105).

If, in S105, determining that the determination button 21e is not pushed, the display condition setting unit 28a executes the processing operation in S104.

If, in S105, determining that the determination button 21e is pushed, the display condition setting unit 28a defines the display point of variable characters specified in a screen other than the user registration screen 40, as a password display point for a user name specified in the user name setting text box 41 in the user registration screen 40, and sets the password display condition (S106). Specifically, the display condition setting unit 28a instructs the server 30 to include, in the password display condition information 34a, a password display condition used for the user name specified in the user name setting text box 41 in the user registration screen 40, the password display condition being a password display condition where a screen in which the display point of variable characters is specified is defined as a password display screen and the display point of variable characters specified in this password display screen is defined as a password display point. For example, the display condition setting unit 28a instructs the server 30 to include, in the password display condition information 34a, a password display condition that is used for the user name specified in the user name setting text box 41 in the user registration screen 40 and in which the address book screen 60 is defined as the password display screen and the SMB path display area 62b specified in the address book screen 60 is defined as the password display point.

If the processing operation in S106 is terminated, the display condition setting unit 28a terminates the operation illustrated in FIG. 6.

Next, operation of the image forming system 10 at the time of authenticating a user using a one-time password will be described.

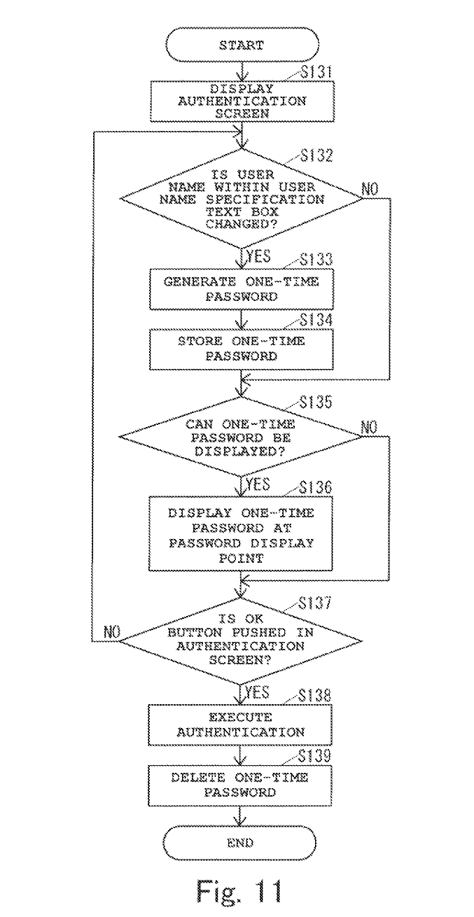

Upon being instructed to start an authentication operation for a user, based on a one-time password, via the operation unit 21, the control unit 28 in the MFP 20 executes an operation illustrated in FIG. 11.

FIG. 11 illustrates steps of the operation of the MFP 20 at the time of authenticating the user using the one-time password.

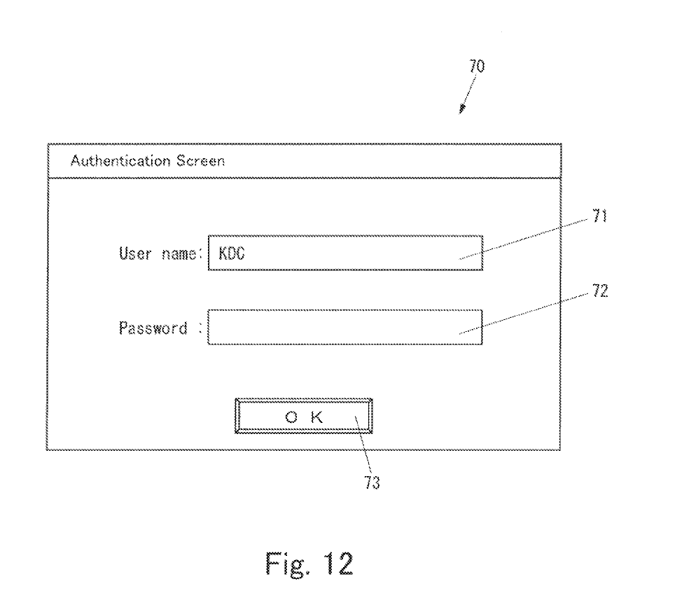

As illustrated in FIG. 11, the control unit 28 displays an authentication screen 70 used for authenticating the user using the one-time password and illustrated in FIG. 12 (S131).

The authentication screen 70 illustrated in FIG. 12 includes a user name specification text box 71 used for specifying a user name, a one-time password specification text box 72 used for specifying a one-time password, and an OK button 73 used for executing authentication. The user is able to input a user name and a one-time password to the user name specification text box 71 and the one-time password specification text box 72, respectively, via the operation unit 21, and is able to push the OK button 73 via the operation unit 21.

As illustrated in FIG. 11, if the processing operation in S131 is terminated, the control unit 28 determines whether or not a user name within the user name specification text box 71 is changed (S132).

If, in S132, determining that the user name within the user name specification text box 71 is changed, the control unit 28 generates a one-time password (S133), and causes the server 30 to store therein the generated one-time password (S134). Specifically, the control unit 28 instructs the server 30 to store therein the password information 34b including the combination of the user name within the user name specification text box 71 and the one-time password generated in S133.

If in S132 it is determined that the user name within the user name specification text box 71 is not changed, or the processing operation in S134 is terminated, the password display unit 28b in the control unit 28 determines whether or not it is possible to display the one-time password (S135). Specifically, when a password display screen set in a password display condition for a user name specified in the user name specification text box 71 is displayed in the display panel 22, the password display condition being included in password display conditions in the password display condition information 34a, in S135 the password display unit 28b determines that it is possible to display the one-time password. If the user operates the operation unit 21 and causes the address book screen 60 to be displayed in the display panel 22 when the user name specified in the user name specification text box 71 is, for example, “KDC” and the password display condition information 34a is information illustrated in FIG. 4, in S135 the password display unit 28b determines that it is possible to display the one-time password.

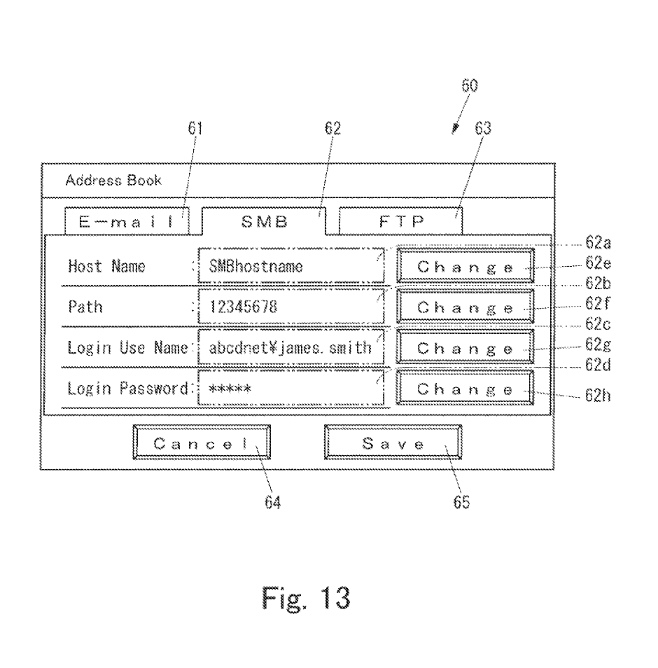

If, in S135, determining that it is possible to display the one-time password, the password display unit 28b displays the one-time password stored in the server 30 in S134, at a password display point set in the password display condition for the user name specified in the user name specification text box 71, the password display condition being included in the password display conditions in the password display condition information 34a (S136). If the user operates the operation unit 21 and causes the address book screen 60 to be displayed in the display panel 22 when the user name specified in the user name specification text box 71 is, for example, “KDC” and the password display condition information 34a is information illustrated in FIG. 4, the password display unit 28b displays the one-time password of “12345678”, in the SMB path display area 62b, as illustrated in FIG. 13.

After confirming the one-time password displayed in the display panel 22, the user is able to input the one-time password to the one-time password specification text box 72 in the authentication screen 70 by operating the operation unit 21.

If in S135 it is determined that it is not possible to display the one-time password, or the processing operation in S136 is terminated, the control unit 28 determines whether or not the OK button 73 is pushed in the authentication screen 70 (S137).

If, in S137, determining that the OK button 73 is not pushed, the control unit 28 executes the processing operation in S132.

If, in S137, determining that the OK button 73 is pushed, the control unit 28 executes authentication, based on the user name specified in the user name specification text box 71 in the authentication screen 70, and the one-time password specified in the one-time password specification text box 72 in the authentication screen 70 (S138). Specifically, if the combination of the user name specified in the user name specification text box 71 in the authentication screen 70 and the one-time password specified in the one-time password specification text box 72 in the authentication screen 70 is stored in the password information 34b on the server 30, the control unit 28 determines that authentication succeeds.

If the processing operation in S138 is terminated, the control unit 28 deletes the one-time password from the server 30 (S139). Specifically, the control unit 28 instructs the server 30 to delete the password information 34b.

If the processing operation in S139 is terminated, the control unit 28 terminates the operation illustrated in FIG. 11.

As described above, the image forming system 10 causes the one-time password to be displayed not at a fixed point but at a display point specified by the user (S136). Therefore, it is possible to reduce the possibility that somebody else viewing a screen displaying the one-time password recognizes the one-time password. In other words, it is possible for the image forming system 10 to improve security performance.

In particular, since, in the image forming system 10, the one-time password is caused to be displayed at the display point of variable characters, it is difficult to recognize whether or not the one-time password is displayed. In other words, it is possible for the image forming system 10 to reduce the possibility that somebody else viewing the screen displaying the one-time password recognizes the one-time password.

In addition, on an assumption that the one-time password only includes numeric characters, only if determining that one of the display points of variable numeric characters is specified in a screen other than the user registration screen 40, the display condition setting unit 28a may define the specified display point as the password display point and set the password display condition. In this case, the control unit 28 generates the one-time password only including numeric characters. As the password display point, for example, the count value of the number of prints or the like may be set. In this configuration, the image forming system 10 causes the one-time password only including numeric characters to be displayed at the display point of variable numeric characters. Therefore, it is difficult to recognize whether or not the one-time password is displayed. In other words, it is possible for the image forming system 10 to reduce the possibility that somebody else viewing the screen displaying the one-time password recognizes the one-time password.

In addition, in the image forming system 10, while it is possible for only the display point of variable characters to be displayed as the password display point in an embodiment, the display point of fixed characters may be specified as the password display point.

The image forming system 10 not only enables the user to specify the password display point but also enables the user to specify the password display screen itself. Therefore, it is possible to reduce a possibility that somebody else viewing a screen recognizes the one-time password.

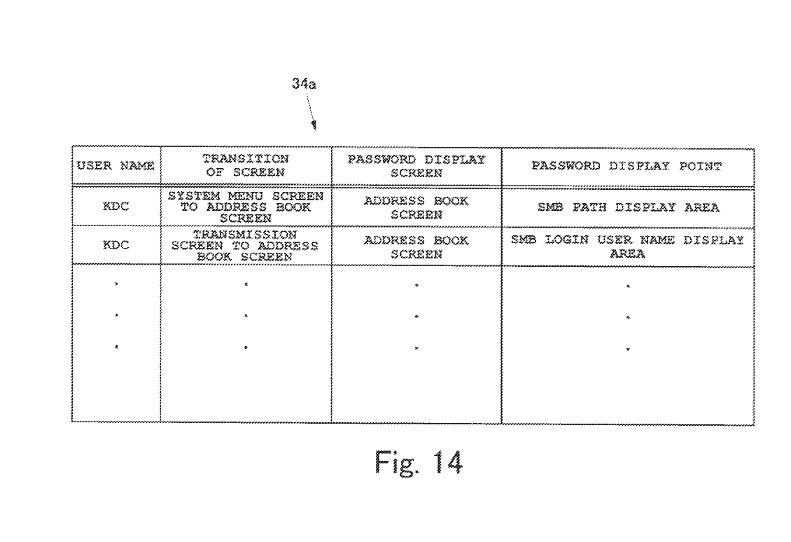

In addition, in the image forming system 10, the transition of a screen ranging to the password display screen may be included in the password display condition. Specifically, after, in S103, determining that the password display condition setting button 42 is pushed, the display condition setting unit 28a may include, in the password display condition, the transition of a screen ranging to displaying of a screen in which the password display point is specified, as illustrated in FIG. 14.

FIG. 14 illustrates an example different from the example of the password display condition information 34a illustrated in FIG. 4.

The password display condition information 34a illustrated in FIG. 14 is information including, with respect to each user name, a password display condition serving as the combination of the user name, the transition of a screen ranging to a password display screen, the password display screen, and a password display point. For example, in the password display condition information 34a illustrated in FIG. 14, a screen transition, a password display screen, and a password display point for the user name, “KDC”, are “system menu screen to address book screen”, an address book screen, and an SMB path display area, respectively.

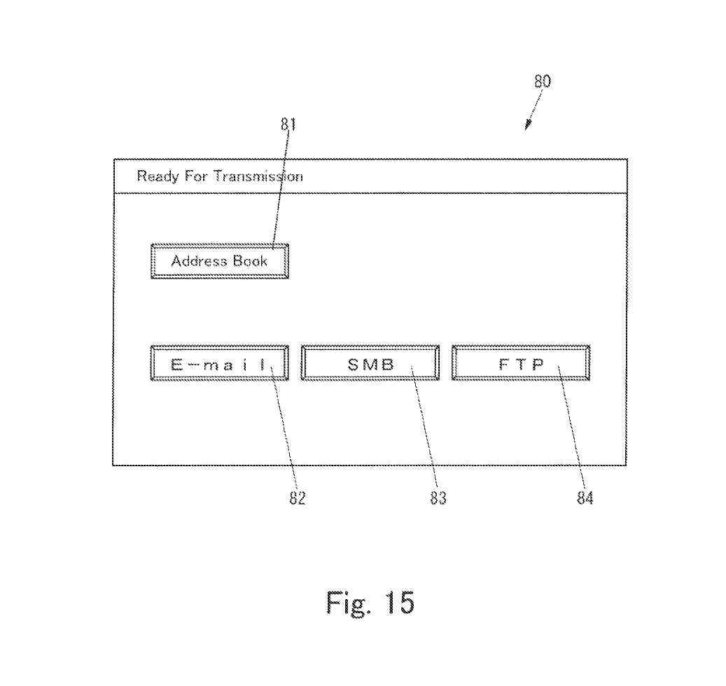

In FIG. 14, “system menu screen to address book screen” indicates that the address book screen 60 illustrated in FIG. 9 is displayed through the system menu screen 50 illustrated in FIG. 8. “transmission screen to address book screen” indicates that the address book screen 60 illustrated in FIG. 9 is displayed through a transmission screen 80 illustrated in FIG. 15.

In addition, the transmission button 21b is pushed, and thus the control unit 28 causes the display panel 22 to display the transmission screen 80 illustrated in FIG. 15.

The transmission screen 80 illustrated in FIG. 15 includes an address book button 81 used for setting an address book, an E-mail button 82 used for executing transmission based on an e-mail, an SMB button 83 used for executing transmission based on an SMB, and an FTP button 84 used for executing transmission based on an FTP.

For example, the address book button 81 is pushed, and thus the control unit 28 causes the display panel 22 to display the address book screen 60 illustrated in FIG. 9.

If the transition of a screen ranging to the password display screen is included in the password display condition, in a situation where (i) a screen is transitioned based on the transition of a screen set in a password display condition for a user name specified in the user name specification text box 71, (ii) the password display condition being included in password display conditions in the password display condition information 34a, and (iii) a password display screen set in this password display condition is displayed in the display panel 22, in S135 the password display unit 28b determines that it is possible to display the one-time password.

If the user operates the operation unit 21 and causes the display panel 22 to display the address book screen 60 through the system menu screen 50 when a user name specified in the user name specification text box 71 is, for example, “KDC” and the password display condition information 34a is information illustrated in FIG. 14, the password display unit 28b determines, in S135, that it is possible to display the one-time password, and displays, in 5136, the one-time password of “12345678” in the SMB path display area 62b, as illustrated in FIG. 13.

On the other hand, if the user operates the operation unit 21 and causes the display panel 22 to display the address book screen 60 through the transmission screen 80 when a user name specified in the user name specification text box 71 is, for example, “KDC” and the password display condition information 34a is information illustrated in FIG. 14, the password display unit 28b determines, in S135, that it is not possible to display the one-time password, and does not cause the one-time password of “12345678” to be displayed in the SMB path display area 62b. Accordingly, in the display panel 22, the address book screen 60 illustrated in FIG. 9 is displayed.

As described above, when the transition of a screen ranging to the password display screen is included in the password display condition, the image forming system 10 not only enables the user to specify the password display point but also causes the user to specify the transition of a screen ranging to the password display screen, as the password display condition. Therefore, it is possible to further improve security performance.

The transition of a screen included in the password display condition may not be a transition including one movement between two screens as illustrated in FIG. 14 but a transition including two or more movements between two or more screens. In the image forming system 10, as the transition of a screen included in the password display condition becomes more complex, it is possible to further improve security performance.

In addition, in the image forming system 10, while, in S106, the determination button 21e used for setting the password display condition is pushed, a button of software to be displayed in the display panel 22 may be adopted in place of the determination button 21e. In the image forming system 10, when a password display point is specified in, for example, the address book screen 60, the Save button 65 in the address book screen 60 may be adopted as a button for setting the password display condition.

In addition, in the image forming system 10, one display point is just specified in a screen other than the user registration screen 40, and thus the password display condition in which the specified display point serves as the password display point may be set.

In addition, the image forming system 10 may include no server 30. In other words, the MFP 20 may include all the functions of the server 30.

While a one-time password display apparatus of the present disclosure is an MFP in an embodiment, if being an apparatus that executes authentication based on a one-time password, the one-time password display apparatus may be an image forming apparatus other than the MFP, such as a printer-dedicated apparatus, a copy-dedicated apparatus, or a facsimile-dedicated apparatus, and may be a computer other than the image forming apparatus, such as an automated teller machine (ATM), a personal computer (PC), or a smartphone.

It should be understood that various changes and modifications to the embodiments described herein will be apparent to those skilled in the art. Such changes and modifications can be made without departing from the spirit and scope of the present subject matter and without diminishing its intended advantages. It is therefore intended that such changes and modifications be covered by the appended claims.

What is claimed is:

1. A display apparatus comprising:
a display panel;
a display condition setting unit that defines a specified display point in a specific screen as a display point of a one-time password for a specified user and sets a display condition for the one-time password; and
a password display unit that displays, to the specified user, the one-time password at a display point included in the display condition based on the display condition set by the display condition setting unit when the specific screen is displayed in the display panel.

2. The display apparatus according to claim 1, wherein
the display condition setting unit enables only a display point of variable characters in the specific screen to be specified as the display point of the one-time password included in the display condition.

3. The display apparatus according to claim 2, wherein
the variable characters are variable numeric characters.

4. The display apparatus according to claim 1, wherein
the display condition setting unit causes a specified screen to be included in the display condition as the specific screen.

5. The display apparatus according to claim 4, wherein:
the display condition setting unit causes a transition of a screen ranging to the specific screen to be included in the display condition; and
the password display unit causes the one-time password to be displayed, to the specified user, at a display point included in the display condition when the specific screen is displayed in the display panel based on a transition of a screen included in the display condition, and the password display unit does not cause the one-time password to be displayed, to the specified user, at a display point included in the display condition when the specific screen is displayed in the display panel based on a transition different from a transition of a screen included in the display condition.

6. A display method comprising:
setting, via a display condition setting unit, a display condition of a one-time password while defining a specified display point in a specific screen as a display point for the one-time password for a specified user; and
displaying, via a password display unit, the one-time password at a display point included in the display condition, to the specified user, based on the display condition set by the display condition setting unit when the specific screen is displayed in a display panel.

7. A non-transitory computer-readable recording medium storing therein a display program executable by a computer, the one-time password display program comprising:
a first program code that causes the computer to define a specified display point in a specific screen as a display point for a one-time password for a specified user and set a display condition of the one-time password; and
a second program code that causes the computer to display, to the specified user, the one-time password at a display point included in the display condition based on the display condition set by the first program code when the specific screen is displayed in a display panel.
